(19) United States
(12) Patent Application Publication
(10) Pub. No.: US 2006/0207046 A1
(43) Pub. Date: Sep. 21, 2006

(54) Powder applicator

(75) Inventors: Lance Fuller Manlove, Seaford, DE (US); R. Dion Lamb, Rehoboth Beach, DE (US)

Correspondence Address: JEFFREY C. LEW, 2205 SILVERSIDE ROAD, WILMINGTON, DE, 19810, US

(73) Assignee: Class 5 Holdings, Inc., Rehoboth Beach, DE (US)

(21) Appl. No.: 11/375,189

(22) Filed: Mar. 14, 2006

Related U.S. Application Data
(60) Provisional application No. 60/663,351, filed on Mar. 19, 2005.

(51) Int. Cl. B05D 1/12; C23C 26/00; A47K 7/02

(52) U.S. Cl. 15/227; 427/180; 427/11; 2/159

(57) ABSTRACT

A manually operable fine powder applicator has a pouch with an outer wall of pliant porous fabric and a layer of fabric adjacent the opposite side of the pouch. Space between the layer and the pouch forms a pocket such that the applicator can be worn on a hand. Fine powder stored inside the pouch can pass through the porous wall to the outside surface of the applicator usually upon tapping or shaking. This exposed powder is transferred to an object bearing coarse particulate matter to be removed, such as beach sand, by contacting the applicator to the object. Gentle wiping action mixes the powder with the particulate matter and tends to easily and quickly remove particulate matter from the object. Cleanup does not require water or other liquid agents.

This application claims priority of U.S. provisional application Ser. No. 60/663,351 filed Mar. 19, 2005.

### FIELD OF THE INVENTION

This invention relates to a device for controlled dispensing of powder to an object, such as for cleaning foreign matter contamination from an object. More specifically it pertains to a powder applicator preferably worn like a glove and which dispenses a fine talc-like powder through a porous wall such that the powder contacts the foreign matter and renders the contaminant easily brushed from the object by motion of the applicator.

### BACKGROUND OF THE INVENTION

Frequently at work and play people find that their clothes or skin comes in contact with usually coarse particulate matter such as dirt or sand. Naturally there is a desire to remove this foreign matter. However due to the particular circumstances, liquid cleaning materials including water might not then be currently available. In that event the usual course of action is to brush the particulate matter away with a cloth or even bare hands. Such efforts have variable effectiveness.

This problem is particularly prominent during recreation at the sea shore. There it is common for people to wear abbreviated clothing that exposes large areas of the skin. At the same time much gritty sand is present on the beaches. The effects of wind and typical recreational activities, such as beach volleyball to name one example, create contact between sand and body. Perspiration from ambient heat that attracts people to the beach environment tends to cause the sand to stick to the skin and renders brushing the sand away more difficult. If shower water is not available as is often the case at many seaside locations, one normally resorts to wiping the sand off the skin. Not only is this a tedious process but it can be irritating and even somewhat painful due to the abrasiveness of the sand. The problem of having to remove sand at the beach can be acute with small children because they are prone to get very sandy over much of their bodies, they have tender skin, and they are easily irritated and resist standing still to facilitate the cleaning efforts.

Cleaning sand and/or dirt from skin at the beach is not the only situation in which removing particles from objects can be problematic. Other representative examples come to mind such as: removing wood chips/dust from clothes, skin and work area objects after power sanding, removing fiberglass dust particles from skin when working in an area where fiberglass insulation is present, removing sand from bodies and gear involved in military or non-military activities in arid regions, cleaning up in remote locations such as campsites where natural water is scarce and water conservation is important, and cleaning an object of a composition, such as delicate fabric or paper, would be degraded by treatment with a liquid.

It is highly desirable to have a simple, convenient and inexpensive way to remove coarse particulate matter from skin, clothing and other objects. The ability to remove such particles without recourse to application of water or other liquid cleaning agent is needed. It is desired to have a quick, gentle and non-irritating method of cleaning gritty sand from skin. To have a device for performing such cleaning that is light, re-usable, convenient to carry and store is further desired.

Also with respect to many mainly outdoor activities skin, clothing or other objects are exposed to deleterious ambient conditions such as sun, wind, insect or animal bites and stings, and the like. Various topical treatments are available to treat these things before or after exposure to reduce the adverse severity of the effect. Typically, the treatments are liquids or creams. These must be carried in leak-resistant containers, are usually heavy due to the weight of the liquid, and are awkward and/or messy to dispense. Treatments in powder form are usually dispensed from containers with perforated lids. A cap is removed to expose the perforations and the powder is poured through the lid. Although some perforated lids may have devices to modify the size of the openings, dispensing powder from such a container tends to dump the powder onto the receiving surface with variable results. The user then spreads the powder in a separate step for uniform coverage. Frequently there is over-spray of the powder deposited from a perforated lid which causes additional mess and waste of material. It is desirable to apply a controlled dose of a powder to a surface of an object to achieve uniform coverage with minimal waste.

### SUMMARY OF THE INVENTION

Accordingly, the present invention provides a manually operable fine powder applicator that can be worn like a glove when used. Tapping or shaking causes powder particles stored inside a pouch typically in the palm area of the applicator to pass through a porous wall and deposit in controlled amount onto the external surface of the applicator. The pouch is worn by inserting the hand into a grip such as a close-fitting pocket formed by a fabric layer on the side of the applicator opposite the porous wall. In a preferred utility, contacting an object bearing coarse particulate matter dispenses the powder particles to mix with the coarse matter, tends to loosen the attraction between the coarse matter and the object, and permits gentle wiping action of the applicator to sweep the coarse matter away from the object.

The invention further provides a powder applicator comprising a pliant pouch containing a powder of particles of size within a preselected particle size range and a gripping means for removably fitting the pouch to be worn on a human hand, in which the pouch comprises at least one porous wall of a material having a pore size effective to pass particles of the powder through the wall at a limited rate.

There is also provided a method of depositing a powder onto a surface of an object comprising the steps of: (A) providing a substantially glove-shaped powder applicator comprising (i) a pliant sealed pouch containing a powder of particles of size within a preselected particle size range, the pouch comprising on one side a porous wall of a material having a pore size effective to pass particles of the powder through the wall at a limited rate and a barrier wall impervious to the particles on a side opposite the porous wall, and (ii) a layer of fabric adjacent the barrier wall which fabric is affixed to less than the whole of the periphery of the barrier wall to define an open-ended pocket between the layer and the barrier wall, (B) inserting a hand into the pocket, (C) tapping or shaking the applicator effectively to cause a portion of the powder inside the pouch to pass through the porous wall and to settle onto an external surface of the porous wall, and (D) contacting the external surface of the applicator with the object and wiping the surface of the object with the applicator, thereby depositing an amount of the powder uniformly on the surface of the object.

Still further this invention provides a powder application system comprising (I) an easily opening, sealed packet containing a preselected amount of a powder of particles of size within a preselected particle size range, and (II) a substantially flat, glove-shaped powder applicator comprising (a) a first wall porous to fine powder particles and having a porosity effective to pass the particles through the first wall at a limited rate, (b) a second wall impervious to the fine powder particles and positioned coextensively with the first wall, the two walls being joined continuously at their periphery to form a sealed pouch defining an internal chamber, (c) a re-sealable port in at one of the walls, the port being operative to admit the packet into the chamber, and (d) a fabric layer adjacent to and a layer of fabric adjacent to the second wall and bonded to the applicator only by part of the periphery of the walls to define a pocket adapted to receive a human hand between the layer of fabric and the second wall.

### BRIEF DESCRIPTION OF THE DRAWINGS

FIG. 1 is a perspective view of a powder applicator according to an embodiment of this invention.

FIG. 2 is a side elevation view of the powder applicator of FIG. 1.

FIG. 3 is a schematic representation of a side section view of the powder fabricator of FIG. 2.

FIG. 4 is an exploded side elevation view of another embodiment of the novel powder applicator.

### DETAILED DESCRIPTION OF THE INVENTION

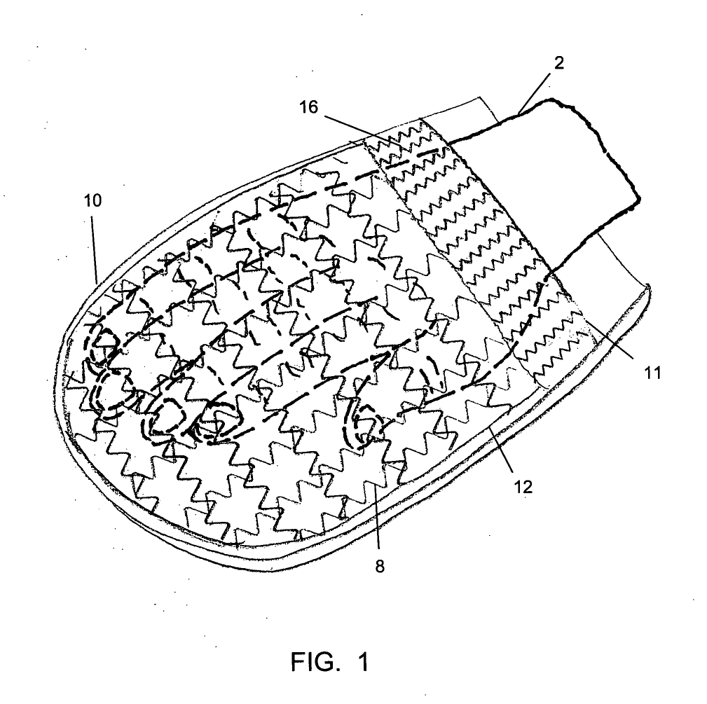

The invention can be understood with reference to FIGS. 1-3 which illustrate different views of one embodiment of the novel powder applicator 10 while it is worn on a hand 2. At its bottom as shown in these drawings, the applicator has a pouch 4 formed by a first lower wall 6 and second upper wall 5. The pouch contains an amount of free flowing, fine particle size powder 7. The applicator also includes a gripping means for removably fitting the applicator to the hand. In the illustrated embodiment, the gripping means is a layer 8 of fabric. In a preferred embodiment, the fabric of the gripping means layer is an open mesh knit or net that is adapted to give way and expand when the applicator is placed on the hand. The layer of fabric can be fully coextensive with the area of the pouch, however, as shown, it is only partially coextensive. Thus it is seen to terminate at edge 11. The layer of fabric is only affixed to the pouch at the pouch periphery 12. The open space 13 between the layer of fabric and the outer surface of upper wall 5 forms a pocket into which the hand may be inserted. The illustrated applicator also has an optional band 15 of elastic material attached to layer 8 and extending across the full width of the applicator. The band is attached to the layer while the elastic is under tension in a stretched state. The band contracts when the tension is released as represented by the gathers 16. When the applicator is donned by inserting the hand into the pocket, the band is stretched and some elastic force is created to help retain the applicator on the hand.

As mentioned, the powder in the pouch is composed of particles having particle size in a pre-selected range. The particles are very small on the size scale of conventional medicinal talcum powder. The powder is dry and resides inside the pouch in a quiescent, free flowing state.

The walls of the pouch are selected to provide special properties in relation to the powder. At least one of the pouch walls is porous. In the illustrated embodiment the lower wall 6 is porous. The size of the pores is selected to permit the fine powder particles to pass through the wall from inside the pouch to the outer surface of the wall.

It should be understood that a significant feature of the novel applicator is that the powder passes through the porous wall at a limited rate so that only a small amount of powder transfers in short intervals. The powder does not pour through the wall. This places an upper limit on the porosity of the porous wall. If the pores are too large, too much of the powder will transfer out of the pouch quickly. Because only a small amount of powder in relation to the amount of coarse particulate matter is sufficient to help remove the coarse matter, it is wasteful and messy to have the powder flow out of the pouch too fast.

Preferably the porosity of the porous wall should be such that some energy is imparted to the powder to cause it to pass through the wall. That is, it is desirable that at most trace or negligible amounts of powder pass through the wall under force of gravity alone while the applicator is in a quiescent state, e.g., sitting still on a level surface. Furthermore, it is preferred that gentle jarring of the applicator causes small portions of the powder to pass. Such jarring occurs for example when the user wearing the applicator on one hand either gently shakes the applicator in a direction normal to the plane of the palm or lightly pats the applicator against the object to be powdered or against the palm of the user's other hand. When the proper relationship between powder particle size and wall porosity is established, very little powder comes through the wall when the applicator is still and only a small dusting of powder appears on the outer surface of the porous wall when the applicator is tapped or shaken. The absolute size of the powder particles and the pores of the porous wall is not critical but can be determined with little experimentation by one of ordinary skill in the art following the teachings of this disclosure.

The ratio of powder to coarse particulate matter effective to remove the coarse matter depends on diverse factors such as the compositions of the coarse matter and the object from which it is to be removed, and whether the coarse matter is adhered to the object for example by perspiration or other tacky substance. Without wishing to be bound by any particular theory it is suggested that the function of the novel applicator, that is the removal of coarse particulate matter from the object, occurs as a result of the partitioning effect of the powder particles. That is to say, the fine powder particles dispense from the outer surface of the porous wall onto the surface of the object contaminated with coarse matter. Wiping the object with the applicator tends to mix the fine powder particles and the coarse particles and to coat the surfaces of the coarse particles with powder. The powder thus creates a barrier between the coarse particle and the surface of the object being cleaned. It breaks or interferes with the bond between the coarse particles and the object, perhaps by absorbing liquid adhesive such as perspiration in the representative case of sand on skin, so that further wiping readily dislodges the coarse particulate matter. Based on this theory, a very small ratio of powder to coarse particles should suffice to partition the particles from the object. It is a beneficial result that only small amounts of powder are utilized for each application and consequently the amount of powder charged in each applicator can be small and will last a long time.

The upper wall 5 faces the palm of the hand 2. Although the upper wall might be composed of the same material of the lower pouch wall and therefore could in theory be porous, such structure permits powder to pass through the upper wall into the pocket and in contact with the user's hand. This is less desirable and consequently it is preferred that the upper wall 5 of the pouch is impervious to the powder. That is, the upper wall can be nonporous or it can have pores provided that the pores are small enough to reject the powder from passing to the palm side of the pouch. The entire upper wall can be impervious to the powder or the upper wall can be a composite of multiple layers at least one of which is effective to prevent transfer of the powder through the upper wall. For example, when it is desired to have a plush fabric feel against the user's palm, the upper wall can be formed from a combination including an outer porous fabric and an internal nonporous film coextensive with the outer porous fabric. The powder inside the pouch is prevented by the film from reaching the porous outer layer.

Powder for use in this invention is free flowing, dry and fine particle size. Powder such as found in typical conventional medicinal and cosmetic products should be suitable. The powder composition can be natural mineral, organic compositions or mixtures thereof. Representative natural mineral compositions include talc (Mg₃Si₄(OH)₂), baking soda sodium bicarbonate or NaHCO3), barium sulfate, titanium dioxide, zinc oxide, silica (SiO₂), hydrated silica, silicone-treated silica beads, mica, calcium silicate, bentonite, hectorite, kaolin, and chalk. Representative organic compositions are cereal starches such as corn starch and rice starch, and the like. A preferred powder is a blend of about 79 wt % corn starch and about 21 wt % baking soda.

The particle size of the powder should be in about the same as that of conventional cosmetic powder. Preferably the powder particles should be in the range of 0.01-100 μm size and more preferably in the range of about 0.1-50 μm. The powder can optionally include components such as pigments, aromatic agents (perfumes), anti-bacterial agents (microbicides) and the like to provide auxiliary functions like deodorizing, coloring, germ-killing etc.

The amount of powder residual inside the pouch diminishes as the applicator is used. In one aspect, a single charge applicator is provided with a preselected amount of powder sealed within the pouch. The applicator may be fabricated with single or a very small number of repeat uses intended before the applicator is spent and discarded. In such “disposable” applicator the preselected amount of powder is just enough to provide few uses before it is exhausted. In another preferred embodiment, a finite but larger amount of powder is sealed within the pouch. The amount is chosen to permit the single charge to supply repeated uses expected to occur over an extended period of time, such as the duration of a typical summer season. Eventually, when all of the powder is consumed, the applicator ceases to function further and can be discarded.

In another aspect, a multiple charge applicator can be fabricated for refilling by the user to replenish the stock of powder inside the pouch as the initial stock depletes. The multiple charge applicator further includes a re-sealable port on the pouch through which a replenishing supply of the powder can be inserted. Any conventional technique for sealing the port can be used. For example, the port can have a removable air-tight pressure fit or screw-type cap, or the pouch can have an opening formed by two sheets of film that meet at an elongated interlocking cross section profile. A path between the films that can be opened or closed by sliding an actuator along the length of the joint. This type of closure mechanism is well known closure for plastic bags identified by the “Zip-Loc”®. Other representative contemplated port closures for sealing the replenishment port include zippers, hook and loop style fasteners and adhesive strips. The applicator can be recharged when appropriate by opening the port, pouring into the pouch a fresh supply of powder and resealing the port.

The body of the applicator, i.e., the pouch and gripping means should be light weight and pliant and generally soft, plush materials so that they are comfortable to the wearer and gentle to the surface being cleaned of coarse particles. Preferably the flexibility of the applicator is such that it can conform to curved or textured objects such as curvature of a person's arm or leg. Preference is given to utilizing a porous fabric, such as terry cloth, or open cell porous foam for the porous wall of the pouch. The composition can be natural, e.g., cotton and wool, or synthetic material. The nonporous wall of the pouch can be a film such as polyvinyl chloride, polyethylene and the like, or a tightly woven fabric which optionally can be treated with a coating composition to increase its resistance to passage of powder particles. A preferred fabric for the layer of the gripping means is an expandable, open mesh netting although any fabric having adequate stretch characteristics to permit the layer to lie substantially close to the pouch with the hand absent and to expand to accept a hand inserted in the pocket should be acceptable. Open mesh helps to keep the interior of the pocket clean and free of stray coarse particulate matter. The expandable fabric layer of the gripping means optionally can be reinforced with a band of elastic material to improve elasticity and gripping power maintaining the applicator on the hand. The elastic component can range from one or more elastic threads to a band of fabric woven or knitted with elastic threads to a width of about 0.25-1 inch or more. Optionally, the whole layer of fabric constituting the gripping means can be of an elastic composition.

Various body shapes for the applicator are contemplated. For example, in addition to the palm pad style embodiment of FIGS. 1-3, a thumb-and-four-fingered mitten style may be used. This embodiment has two lobes, one for the thumb and a second to accommodate the other fingers of a hand. This has the advantage of providing greater flexibility of the applicator to conform more closely to curved or angular surfaces to be cleaned. A glove-shaped embodiment having a lobe for each finger, as in a conventional glove, is also envisioned. Although a rounded-end palm pad shape is shown in FIGS. 1-3, other palm pad shapes such as rectangular, triangular, higher order polygonal or irregular outline shapes are deemed to be embraced within the scope of this invention.

The applicator can be fabricated in a variety of diverse ways. In one contemplated method, the lower porous pouch wall, the upper preferably nonporous pouch wall, and the layer of fabric for the gripping means are cut to shape and stacked in appropriate order. Then the layers are joined at their common periphery while assuring to leave a portion of the edge of the gripping means fabric free to accept insertion of a hand. The layers at the peripheral edge of the applicator can be joined by sewing, adhesive bonding or similar conventional technique.

Heretofore, emphasis has been placed upon the gripping means as being a layer of fabric attached at the periphery of the applicator body with a peripheral portion unattached to provide an opening for inserting the hand of the wearer. The gripping means is intended to hold the applicator on the wearer's hand securely while in use yet to permit the user to relatively easily take the applicator off the hand. Alternative embodiments of the gripping means are thus also contemplated. For example, a glove can be attached to the outer surface of the upper pouch wall. The user inserts a hand in the glove to don the applicator. Similarly, a series of strap-like loops or pockets for individual fingers preferably of a fabric material and about 0.25-0.5 inch wide can be secured to the outer surface of the upper wall in positions to allow the user to insert several fingers individually into the loops or pockets in the manner of slipping rings on the fingers. Another representative embodiment utilizes one or more elastic bands spanning the width of the applicator on the upper wall side (i.e., without a fabric layer). Yet another exemplary embodiment involves attaching at least one strap by one end to a peripheral edge of the pouch and providing at the free end of the strap a fastener such as a snap fastener, hook-and-loop fastener (sometimes known by the well known “Velcro”® tradename), button and hole fastener or the like to cinch the strap across the back of the hand.

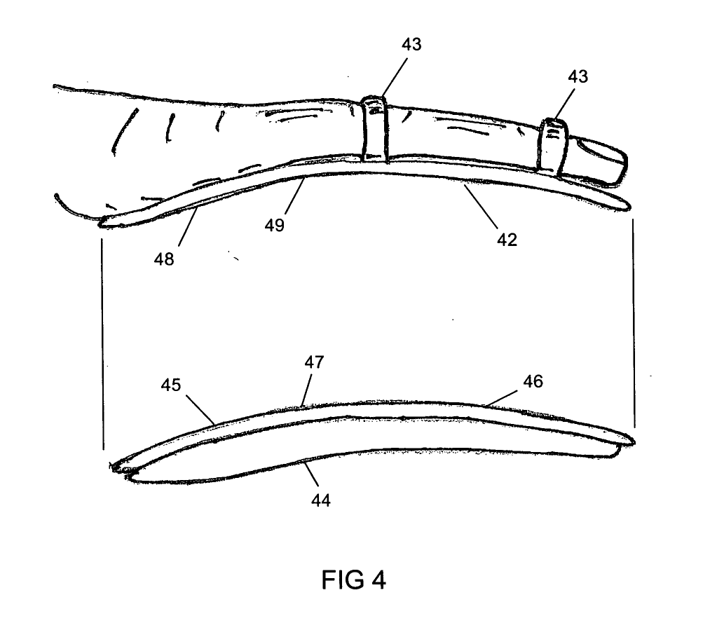

In another contemplated embodiment, the gripping means and pouch are separable as can be understood with reference to FIG. 4. The gripping means 42 is a glove-like element. It comprises a gripping pad 48 and a plurality of straps forming loops 43. The loops are permanently affixed to the surface of the gripping pad facing the palm of hand 2. The pad is worn on the hand by inserting the fingers through the loops into position as shown. This embodiment of the applicator also includes a detachable pouch element 45. The pouch element comprises a mounting mat 46 to which is permanently affixed a powder-containing pouch 44. In plan view (not shown) the gripping pad and mounting mat have similar geometric shape. The gripping pad and mounting mat are generally thin in comparison to the thickness of the pouch and they can be formed of flexible fabric, film or the like. The mounting mat can be a separate element from the pouch or the upper wall of the pouch can also be the mounting mat. Additionally, in the illustrated embodiment the underlying surface 49 of the gripping pad and the overlying surface 47 of the mounting mat include removably attachable fasteners, such as hook and loop fastener components. Hence, the mounting mat with affixed pouch can be brought into coextensive mating contact with gripping pad such that the mat and pad become temporarily attached by operation of the fasteners at least for the duration of use of the powder applicator. When desired, the user can detach the mat from the pad thereby separating the pouch from the gripping means. In another contemplated embodiment (not shown), the gripping pad and mounting mat can be connected with a zipper fastener system extending along the mutual lateral periphery of the gripping pad and mounting mat.

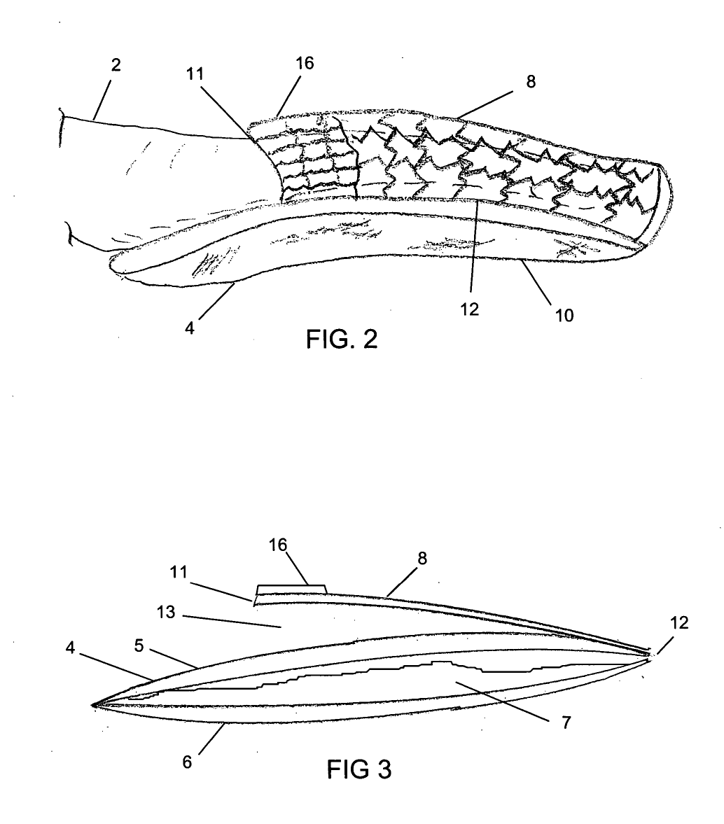

This embodiment has several advantageous features. A first pouch can be replaced with a new pouch when the first is depleted of powder. The gripping pad does not need to be replaced. Also, a user can select a gripping pad of style to suit personal preference such as finger loops shown in FIG. 4, fabric layer as in FIGS. 1 and 2 or other styles described herein. Once the gripping pad is chosen, the user can obtain any number of replacement pouches without having to seek out the preferred gripping pad style. Yet further, the single gripping pad can accommodate any of a selection from a set of pouches each containing different powders adapted for special uses. Thus for example, a pouch can contain a powder for coarse particulate removal. Other pouches can contain sun blocking powder for protection against sunlight exposure, sunburn analgesic powder for easing pain after excessive skin exposure to sunlight, or insect repellant powder, to name a few representative examples.

Thickness of the powder applicator is not critical provided that the pouch has sufficient volume to accept a practical minimum supply of powder. In one aspect the applicator is substantially flat with a relatively thin cross section. Such configuration advantageously provides the ability to fold the applicator on itself for compactness. For example, the applicator can be “folded in half” with two “halves” of the open porous wall side of the pouch coming together in contact. A separate or integral clasp means, such as an elastic band or string can be tied around the folded applicator to keep it folded. The integral clasp device can take the form of a zipper structure along the outer peripheral edge of the applicator such that the applicator can be zipped up when folded in half. In addition to merely saving space, folding in this manner prevents powder from escaping from the applicator when not in use. It also shields the outer surface of the porous wall from picking up dirt. This is especially beneficial because this outer surface touches the objects to be cleaned, including bare skin. Alternatively to folding the applicator flat on itself, it can be rolled up (i.e., “jelly-roll” or “sleeping bag” style) preferably with the porous wall surface on the inside of the roll.

Optionally the powder applicator can include a loop, cord, clothes pin type clip or like securing means attached to the body, preferably at the periphery of the pouch to conveniently facilitate hanging the applicator to a hook, beach umbrella, bag or chair.

The powder applicator is useful in diverse situations where coarse particles of a wide variety of types are desired to be removed from surfaces of objects. The terms “coarse particles”, “coarse particulate matter” and similar phrases are not meant to denote a size limitation on the particles. These terms are used herein as a nomenclature convention to differentiate the particulate matter on the objects to be cleaned from the particles of the powder dispensed by the novel powder applicator. Mainly the novel powder applicator is known for ability to clean sand from skin, clothing and other objects. It is useful at sandy beaches and in arid, dusty regions. It can be used to help remove sand and dirt particles from personnel and equipment in remote military installations where sand is prominent and water is relatively scarce. The applicator facilitates the removal of paint dust, sawdust, wood chips, and dust produced by cutting, grinding and otherwise abrading common construction materials such as drywall, concrete, brick, rubber, fabric and the like. This invention is also well suited to removing fibrous dust that settles on skin and clothes from contact with building insulation such as fiberglass insulation batts.

The novel powder applicator is also well suited to applying powder to skin clothing and other objects uniformly in controlled amounts for many purposes. The applicator can be used for example in methods of applying sunlight blocking powder that can optionally contain ultraviolet light absorbing components to reduce risk of harmful exposure to the rays of the sun; applying powdered insect repellant to ward off attack from irritating or stinging insects; applying powdered anti-microbial agents to treat wounds and control disease, such as foot fungus infestations; evenly applying powder to babies; applying powdered dry shampoo to humans and pets, applying flea powder to pets, applying powdered soothing and analgesic agents to reduce pain from sunburn, insect bites, jellyfish stings, and the like.

In operation, the user may unpackage a new applicator, or unfold or unroll a previously used and stored applicator. The user inserts a hand into the pocket such that the palm is in contact with the outer surface of the nonporous wall of the pouch and the porous wall is facing away from the user. The user taps lightly on the porous wall side of the pouch with the user's other hand or shakes the applicator forward and back a few times with a jerking motion. This deposits some powder onto the outer surface of the porous wall of the pouch. The user places the powder bearing outer surface of the applicator in contact with the object onto which powder is to be deposited and optionally to be cleaned, such as a clothed or bare portion of a person's body that has sand on it. The user gently wipes the object with lateral brushing strokes to place powder on the object and to remove the particles on the object. After use, the applicator can be folded up, rolled up or otherwise stored for later reuse. The novel applicator presents the advantage over conventional powder dispensers that the powder is largely deposited in direct contact with the surface to be covered and with a minimum of powder entrained in the ambient air. Thus little powder is wasted and the risk of the user inhaling powder present as dust in the air is much reduced.

Although specific forms of the invention have been selected in the preceding disclosure for illustration in specific terms for the purpose of describing these forms of the invention fully and amply for one of average skill in the pertinent art, it should be understood that various substitutions and modifications which bring about substantially equivalent or superior results and/or performance are deemed to be within the scope and spirit of the following claims.

What is claimed is:

1. A powder applicator comprising a pliant pouch containing a powder of particles of size within a preselected particle size range and a gripping means for removably fitting the pouch to be worn on a human hand, in which the pouch comprises at least one porous wall of a material having a pore size effective to pass particles of the powder through the wall at a limited rate.

2. The applicator of claim 1 in which pouch is substantially flat defining two side walls one of which being the at least one porous wall.

3. The applicator of claim 2 in which the second wall is impervious to the particles.

4. The applicator of claim 3 in which the gripping means comprises a layer of fabric adjacent the second wall and affixed to the pouch only at a first portion of the periphery of the pouch consituting less than the entire periphery to define a pocket between the layer and the second wall for the hand that can be inserted through an opening defined by a second portion of the periphery of the pouch at which the layer is not affixed.

5. The applicator of claim 4 in which the layer further comprises an elastic element such that insertion of the hand into the pocket is effective to resist removal of the applicator from the hand.

6. The applicator of claim 4 in which the fabric is a knit or open mesh structure.

7. The applicator of claim 2 in which the pouch further comprises a re-sealable port through which a replenishing supply of the powder can be inserted.

8. The applicator of claim 2 which further comprises a securing means for removably attaching the applicator to another object.

9. The applicator of claim 2 in which the pouch and fabric layer are flexible to an extent effective to enable folding of the applicator on itself or rolling up the applicator.

10. The applicator of claim 9 further comprising a clasp operative to maintain the applicator in a folded or rolled up conformation.

11. The applicator of claim 1 in which the pouch is removably attachable from the gripping means.

12. The applicator of 11 in which the pouch further comprises a mounting mat, the gripping means comprises a gripping pad shaped to mate with the mounting mat, and the mounting mat and gripping pad comprise fasteners operative to removably attach the pourch to the gripping means.

13. A method of depositing a powder onto a surface of an object comprising the steps of:
(A) providing a substantially glove-shaped powder applicator comprising (i) a pliant sealed pouch containing a powder of particles of size within a preselected particle size range, the pouch comprising on one side a porous wall of a material having a pore size effective to pass particles of the powder through the wall at a limited rate and a barrier wall impervious to the particles on a side opposite the porous wall, and (ii) a layer of fabric adjacent the barrier wall which fabric is affixed to less than the whole of the periphery of the barrier wall to define an open-ended pocket between the layer and the barrier wall,
(B) inserting a hand into the pocket,
(C) tapping or shaking the applicator effectively to cause a portion of the powder inside the pouch to pass through the porous wall and to settle onto an external surface of the porous wall, and
(D) contacting the external surface of the applicator with the object and wiping the surface of the object with the applicator, thereby depositing an amount of the powder uniformly on the surface of the object.

14. The method of claim 13 in which the object is a human body.

15. The method of claim 13 in which the surface of the object comprises foreign particulate matter and in which step (D) further comprises removing the foreign particulate matter from the surface of the object.

16. The method of claim 13 in which the powder comprises a microbicidal component and the method includes destroying microorganisms on the exposed surface.

17. The method of claim 13 which further comprises not contacting the exposed surface with any liquid.

18. The method of claim 14 in which the foreign particulate matter comprises sand or dirt.

19. A powder application system comprising
(I) an easily opening, sealed packet containing a preselected amount of a powder of particles of size within a preselected particle size range, and
(II) a substantially flat, glove-shaped powder applicator comprising
(a) a first wall porous to fine powder particles and having a porosity effective to pass the particles through the first wall at a limited rate,
(b) a second wall impervious to the fine powder particles and positioned coextensively with the first wall, the two walls being joined continuously at their periphery to form a sealed pouch defining an internal chamber,
(c) a re-sealable port in at one of the walls, the port being operative to admit the packet into the chamber, and
(d) a fabric layer adjacent to and a layer of fabric adjacent to the second wall and bonded to the applicator only by part of the periphery of the walls to define a pocket adapted to receive a human hand between the layer of fabric and the second wall.
